(19) United States
(12) Patent Application Publication
(10) Pub. No.: US 2025/0351144 A1
(43) Pub. Date: Nov. 13, 2025

(54) Multi-PDCCH monitoring and Multi-PDSCH/PUSCH Scheduling in Wireless Communication

(71) Applicant: Apple Inc., CUPERTINO, CA (US)

(72) Inventors: Hong HE, San Jose, CA (US); Chunxuan YE, San Diego, CA (US); Dawei ZHANG, Saratoga, CA (US); Haitong SUN, Saratoga, CA (US); Huaning NIU, San Jose, CA (US); Oghenekome OTERI, San Diego, CA (US); Weidong YANG, San Diego, CA (US); Wei ZENG, Saratoga, CA (US); Yang TANG, San Jose, CA (US); Yushu ZHANG, Beijing (CN)

(21) Appl. No.: 18/722,808

(22) PCT Filed: Jan. 4, 2022
(86) PCT No.: PCT/CN2022/070138

§ 371 Date: Jun. 21, 2024

(51) Int. Cl. H04W 72/23; H04W 24/08; H04W 72/0446; H04W 72/1273

(52) U.S. Cl. CPC H04W 72/23; H04W 24/08; H04W 72/0446; H04W 72/1273

(57) ABSTRACT

A user equipment (UE) is configured to receive, from a network, search space set configurations to monitor physical downlink control channel (PDCCH) including multi-slot PDCCH monitoring parameters for search space sets in a first search space (SS) group and search space sets in a second SS group, the multi-slot PDCCH monitoring parameters including a number of slots X included in a slot group and a number of slots Y used for monitoring the first search space groups in a slot group, determine a length and a location of a monitoring occasion (MO) dropping window (MO-DW) based on a location of a second SS group MO and drop one or more first SS group MOs that fall within the MO-DW.

### TECHNICAL FIELD

The present disclosure generally relates to wireless communication, and in particular, to multi-PDCCH monitoring and multi-PDSCH/PUSCH scheduling in wireless communication.

### BACKGROUND

In a Fifth Generation (5G) New Radio (NR) network, for communication above 52.6 gigahertz (GHz), the subcarrier spacing (SCS) may be increased to provide robustness to phase noise. For example, the SCS may be set to 120 kilohertz (KHz), 480 KHz or 960 KHz. However, increasing the SCS may result in a reduction in the duration of the symbol which may place an unreasonable strain on user equipment (UE) processing resources during, for example, physical downlink control channel (PDCCH) monitoring.

### SUMMARY

Some exemplary embodiments are related to a processor of a user equipment (UE) configured to perform operations. The operations include receiving, from a network, search space set configurations to monitor physical downlink control channel (PDCCH) including multi-slot PDCCH monitoring parameters for search space sets in a first search space (SS) group and search space sets in a second SS group, the multi-slot PDCCH monitoring parameters including a number of slots X included in a slot group and a number of slots Y used for monitoring the first search space groups in a slot group, determining a length and a location of a monitoring occasion (MO) dropping window (MO-DW) based on a location of a second SS group MO and dropping one or more first SS group MOs that fall within the MO-DW.

Other exemplary embodiments are related to a processor of a user equipment (UE) configured to perform operations. The operations include receiving a PxSCH configuration, wherein PxSCH represents a physical downlink shared channel (PDSCH) or a physical uplink shared channel (PUSCH), the PxSCH configuration including a time domain resource allocation (TDRA) table comprising one or more rows with at least one row containing multiple starting length and indicator values (SLIVs) and at least one repetition parameter, receiving a scheduling downlink control information (DCI) indicating one or more rows of the TDRA table and determining a number of repetitions to apply to PxSCH transmissions based on the at least one repetition parameter.

Still further exemplary embodiments are related to a user equipment (UE) having a transceiver configured to communicate with a network and a processor communicatively coupled to the transceiver and configured to perform operations. The operations include receiving, from the network, search space set configurations to monitor physical downlink control channel (PDCCH) including multi-slot PDCCH monitoring parameters for search space sets in a first search space (SS) group and search space sets in a second SS group, the multi-slot PDCCH monitoring parameters including a number of slots X included in a slot group and a number of slots Y used for monitoring the first search space groups in a slot group, determining a length and a location of a monitoring occasion (MO) dropping window (MO-DW) based on a location of a second SS group MO and dropping one or more first SS group MOs that fall within the MO-DW.

Additional exemplary embodiments are related to a user equipment (UE) having a transceiver configured to communicate with a network and a processor communicatively coupled to the transceiver and configured to perform operations. The operations include receiving a PxSCH configuration, wherein PxSCH represents a physical downlink shared channel (PDSCH) or a physical uplink shared channel (PUSCH), the PxSCH configuration including a time domain resource allocation (TDRA) table comprising one or more rows with at least one row containing multiple starting length and indicator values (SLIVs) and at least one repetition parameter, receiving a scheduling downlink control information (DCI) indicating one or more rows of the TDRA table and determining a number of repetitions to apply to PxSCH transmissions based on the at least one repetition parameter.

### BRIEF DESCRIPTION OF THE DRAWINGS

FIG. 1 shows an exemplary set of slot groups within a subframe according to various exemplary embodiments.

FIG. 2 shows an exemplary arrangement of Group 1 and Group 2 according to various exemplary embodiments.

FIG. 3a shows an exemplary diagram of a distribution of monitoring occasions (MOS) for Group 1 search spaces (SS) and Group 2 SS where the monitoring slots are not aligned.

FIG. 3b shows an exemplary diagram of the MOs for Group 1 SS and Group 2 SS of FIG. 3a and an MO dropping window (MO-DW) according to a first option of various exemplary embodiments.

FIG. 3c shows a diagram of the MOs for Group 1 SS and Group 2 SS of FIG. 3a and an MO-DW according to a second option of various exemplary embodiments.

FIG. 3d shows a diagram of the MOs for Group 1 SS and Group 2 SS of FIG. 3a and an MO-DW according to a third option of various exemplary embodiments.

FIG. 3e shows a diagram comprising an MO distribution for Group 1 SS and Group 2 SS where a Group 2 MO is located in the same slot as a Group 1 MO according to various exemplary embodiments.

FIG. 4 shows a method for dropping PDCCH MOs according to various exemplary embodiments.

FIG. 5 shows an exemplary TDRA table and associated repetitions to be applied to each table entry to according to various exemplary embodiments.

FIG. 6a shows an exemplary TDRA table comprising three rows, wherein Row #0 includes 4 SLIVs, Row #1 includes 2 SLIVs, and Row #2 includes 1 SLIV according to various exemplary embodiments.

FIG. 6b shows an exemplary diagram of the repetition behavior for the SLIVs of the TDRA table of FIG. 6a according to various exemplary embodiments.

FIG. 7 shows a method for multi-PDSCH/PUSCH (PxSCH) repetition according to various exemplary embodiments.

FIG. 8 shows an exemplary table for indicating the enabling or disabling of transport blocks (TBs) in multi-PDSCH scheduling according to various exemplary embodiments.

FIG. 9 shows an exemplary network arrangement according to various exemplary embodiments.

FIG. 10 shows an exemplary user equipment (UE) according to various exemplary embodiments.

FIG. 11 shows an exemplary base station according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques for multi-slot physical downlink control channel (PDCCH) monitoring, multi-PDSCH/PUSCH (PxSCH) scheduling with PxSCH repetition, and transport block (TB) disabling in multi-PDSCH scheduling.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

In a Fifth Generation (5G) New Radio (NR) network, for communication above 52.6 gigahertz (GHz), the subcarrier spacing (SCS) may be increased to provide robustness to minimize the impact of phase noise. For example, the SCS may be set to 120 kilohertz (KHz), 480 KHz or 960 KHz. However, increasing the SCS may result in a reduction in the duration of the symbol. From the perspective of the UE, the reduction in symbol duration may increase the number of operations that are to be performed by the UE for PDCCH monitoring which may place an unreasonable strain on UE processing resources and significantly drain UE power.

It has been identified that it may be beneficial to utilize multi-slot PDCCH monitoring (MSM) for communication above 52.6 GHZ. MSM may allow the UE to avoid the processing strain associated with other PDCCH monitoring approaches. However, while the exemplary techniques described herein may provide benefits to 5G NR communication above 52.6 GHZ, the exemplary embodiments are not limited to this frequency range.

MSM may generally refer to a PDCCH monitoring approach that is based on slot groups that each comprises a number of consecutive slots represented by ‘X’. As will be described in more detail below, for MSM, the UE may perform PDCCH monitoring during (Y) slots of each slot group. To provide a general example, if X=4 slots and Y=1 slot, the UE may perform PDCCH monitoring in 1 slot out of the 4 consecutive slots.

FIG. 1 shows an exemplary set of slot groups 140-144 within a subframe 130 according to various exemplary embodiments. This exemplary slot group arrangement is not intended to limit the exemplary embodiments in any way and is merely provided as a general overview of the relationship between a slot group and a subframe. A subframe may comprise 1 slot or multiple slots (e.g., 2, 4, 5, 12, 16, etc.) and the exemplary embodiments are not limited to any particular number of slots or slot groups per subframe.

The UE 110 may be configured with a PDCCH that includes multiple subframes 130. In this example, the PDCCH may be configured with a SCS of 480 KHz, corresponding to 32 slots per subframe. FIG. 1 shows a portion of a subframe 130 with 12 slots indexed 0-11. This portion of subframe 130 is arranged into 3 separate slot groups 140-144 and each slot group 140-144 comprises X=4 slots. There are 32 slots per subframe in this example and thus, the remaining portion of subframe 130 that is not pictured in FIG. 1 may include 20 slots indexed 12-31. The slots indexed 12-31 may be arranged into 5 separate groups each comprising X=4 slots. Therefore, while only 3 slot groups 140-144 are shown in FIG. 1, subframe 130 may include a total 8 slot groups with a slot group size of X=4 slots across its 32 slots.

In this example, the UE 110 may be configured to perform PDCCH monitoring in 1 slot from each of the slot groups 140-144 (e.g., Y=1). Thus, in a first slot group 140 comprising slots indexed 0-3, the UE 110 may be configured to monitor a PDCCH SS during slot 1. During slots indexed 0, 2 and 3, the UE 110 has the opportunity to sleep and conserve power since the UE 110 is not configured to perform PDCCH monitoring during the other slots 0, 2, 3. In a second slot group 142 comprising slots indexed 4-7, the UE 110 may be configured to monitor a PDCCH SS during slot 5. During slots indexed 4, 6 and 7, the UE 110 has the opportunity to sleep and conserve power since the UE 110 is not configured to perform PDCCH monitoring during the other slots 4, 6, 7. In a third slot group 144 comprising slots indexed 8-11, the UE 110 may be configured to monitor a PDCCH SS during slot 9. During slots indexed 8, 10 and 11, the UE 110 has the opportunity to sleep and conserve power since the UE 110 is not configured to perform PDCCH monitoring during the other slots 8, 10, 11. The UE 110 may behave in the same manner on the other 5 slot groups referenced above in the remaining portion of subframe 130 that is not pictured in FIG. 1.

Slot groups may be consecutive to one another and not overlap in time. Thus, in this example, slot group 140 comprises slots indexed 0-3, slot group 142 comprises slots indexed 4-7 and slot group 144 comprises slots indexed 8-11. The start of a first slot group in a subframe (e.g., slot group 140) may be aligned with a slot boundary (e.g., slot index 0 (not pictured)). The start of each slot group may be aligned with a slot boundary. In this example, there is no gap between the slot groups 140-144. FIG. 1 is not intended to limit the exemplary embodiments in any way and is merely provided as a general overview of the relationship between a slot group and a subframe. The exemplary embodiments may apply to any appropriate SCS, subframe duration, number of slots per subframe, number of slot groups, slot group size, etc.

A control resources set (CORESET) may be defined and, based on the CORESET, a search space (SS) may be defined. The UE 110 may perform PDCCH monitoring within the SS. The following examples provide a general overview of SSs within the slot group framework.

Throughout this description, reference is made to “Group 1” to identify a first set of consecutive slot groups each comprising (X) consecutive slots and “Group 2” to identify a second set of consecutive slot groups each comprising (B) consecutive slots. However, it should be noted that the terms “Group 1” and “Group 2” do not confer any special meaning to the slot groups. These terms are merely used to distinguish between two different slot groups. In some exemplary embodiments, the Group (1) SS includes a Type 1 CSS with dedicated RRC configuration and type 3 CSS, with UE specific SS. The RRC configuration may occur every slot/multi-slot. In addition, in some exemplary embodiments, Group (2) SS includes Type 1 CSS without dedicated RRC configuration and type 0, 0A, and 2 CSS. This may be configured before RRC configuration and typically, does not occur as often, e.g., Type 0 may occur once every 20 msec and Type 2 (paging) occurs in idle mode. However, this is only an example and the “Group 1” and “Group 2” slot groups are, as described above, not limited to any particular type of slot groups.

The slot group size (X) for Group 1 may be the same as or different than the slot group size (B) for Group 2. Group 1 and Group 2 may be each be associated with the same or different frequency resources and overlap (fully or partially) in the time domain. The examples provided below mention Group 1 specific parameters (e.g., slot group size X and PDCCH span Y) and Group 2 specific parameters (e.g., slot group size B and PDCCH span A). In some embodiments, the Group 1 specific parameters and the Group 2 specific parameters may be the same value. In this type of configuration, a single parameter may be used to represent both the slot group size for Group 1 and the slot group size for Group 2. Similarly, in this type of scenario, a single parameter may be used for both the PDCCH monitoring span for Group 1 and the PDCCH monitoring span for Group 2. For example, instead of utilizing/signaling an X and B parameter the network and/or the UE 110 may utilize X for both Group 1 and Group 2. Instead, of utilizing/signaling a Y and A parameter the network and/or the UE 110 may utilize Y for both Group 1 and Group 2. In some embodiments, the Group 1 specific parameters and the Group 2 specific parameters may be the same value for some parameters and different values for others. In this type of configuration, a single parameter may be used to represent both the slot group size for Group 1 and the slot group size for Group 2. Separate parameters may be used for the PDCCH monitoring span for Group 1 and the PDCCH monitoring span for Group 2. For example, instead of utilizing/signaling an X and B parameter the network and/or the UE 110 may utilize X for both Group 1 and Group 2. We then utilize/signal a Y and A parameter from the network and/or the UE 110 may utilize Y for Group 1 and A for Group 2.

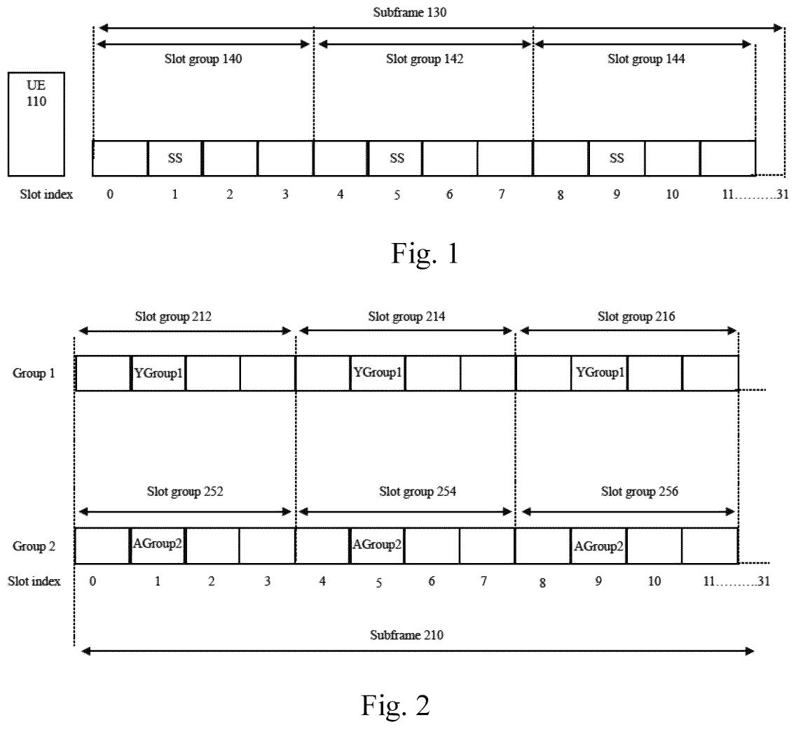

FIG. 2 shows an exemplary arrangement of Group 1 and Group 2 according to various exemplary embodiments. FIG. 2 includes a portion of a subframe 210 with slots indexed 0-11. Group 1 and Group 2 are be located on a same or different frequency domain and may overlap in the time domain. This arrangement of Group 1 and Group 2 is not intended to limit the exemplary embodiments in any way and is merely provided as a general overview of the relationship between a Group 1 and Group 2.

In this example, Group 1 is configured with slot groups 212-216 that each comprise (X=4) slots. Thus, in this example, the slot group 212 includes slots indexed 0-3, the slot group 214 includes slots indexed 4-7 and the slot group 216 includes slots indexed 8-11. The arrangement of slot groups in this example may be similar to the example provided in FIG. 1 with regard to subframe 130.

Similarly, Group 2 is also configured with slot groups 252-256 that each comprise (B=4) slots. Thus, the slot group 252 includes slots indexed 0-3, the slot group 254 includes slots indexed 4-7 and the slot group 256 includes slots indexed 8-11. In this example, the arrangement of slot groups in Group 1 and Group 2 are the same.

In FIG. 2, the depicted arrangement of Group 1 and Group 2 is not intended to limit the exemplary embodiments in any way and is merely provided as a general overview of the relationship between a Group 1 and Group 2. The exemplary embodiments may apply to any appropriate SCS, subframe duration, number of slots per subframe, number of slot groups, slot group size, etc. Additional information regarding the relationship between Group 1 and Group 2 will be provided below.

A Group 1 SS may be configured within (Y) consecutive slots of a slot group with a slot group size of (X) consecutive slots. Similarly, a Group 2 SS may be configured within (A) consecutive slots of a slot group with a slot group size of (B) consecutive slots. To differentiate between the SS slots for Group 1 and the SS slots for Group 2, reference may be made to “YGroup1” representing the (Y) consecutive slots of Group1 and “AGroup2” representing the (A) consecutive slots of Group2. In various examples below, YGroup1 and AGroup2 are the same value. However, the exemplary embodiments are not limited to a scenario where YGroup1 and AGroup2 are the same and may apply to YGroup1 and AGroup2 being any appropriate value.

To provide an example within the context of FIG. 2, YGroup1 may be set to 1 slot and be configured to occur every second slot of each slot group 212-216. Thus, the UE 110 may perform PDCCH monitoring for Group 1 during one or more symbols of slot index 1, slot index 5 and slot index 8. AGroup2 may also be set to 1 slot and be configured to occur every second slot of each slot group 252-256. Thus, the UE 110 may perform PDCCH monitoring for Group 2 during one or more symbols of slot index 1, slot index 5 and slot index 8.

The location of YGroup1 within a slot group may be based on a time offset and the time offset may be based on a slot index “n0” determined for Group2 monitoring such that the YGroup1 slots overlap in time with the AGroup2 slots. For instance, continuing with the example shown in FIG. 2, each instance of YGroup1 may overlap in time with each instance of AGroup2. However, while it may be beneficial for YGroup1 and AGroup2 to overlap in time from a PDCCH processing perspective, MSM does not require that Group 1 SS and the Group 2 SS overlap in time (e.g., “n0” for Group 1 may be different than the “n0” for Group 2.

The UE 110 may be configured with a blind decoding (BD)/control channel element (CCE) budget indicating the number of blind decodes and the CCE size supported by the UE 110 within Y or A=max (YGroup1, AGroup2) per slot group. In some embodiments, the UE 110 may be required to report the BD/CCE budget for one or more slot group sizes if the UE 110 supports a SCS associated with a particular slot group size (e.g., 120 KHz, 480 KHz, 960 KHz, etc.). In other embodiments, the UE 110 may not be required to report a BD/CCE budget for a slot group size even if the UE 110 supports the corresponding SCS. In some embodiments, the BD/CCE budget may be hard encoded in 3GPP Specifications or predetermined in any other appropriate manner. During operation, when the UE 110 the BD/CCE budget may be known based on the (X,B) (Y,A) values. For MSM, there may be a common BD/CCE budget for all SSs.

The location of YGroup1 within a slot group may be maintained across different slot groups unless the parameter “no” changes. BD attempts for all Group 1 SSs may fall within the same YGroup1 slots.

The location of the AGroup2 within a slot group is maintained across different slot groups unless the parameter “no” changes. The reported capability indicates the BD/CCE budget within Y or A=max (YGroup1, AGroup2) slots per slot group. To provide some example configurations, when (X) and (B) are both equal to 8 slots, YGroup1 may be equal to 4, 2 or 1 and AGroup2 may be equal to 2 or 1. Thus, X or B=8: (YGroup1, AGroup2)=(4,2), (2,2), (1, [1 or 2]). When (X) and (B) are both equal to 4 slots, YGroup1 may be equal to 2 or 1 and AGroup2 may be equal to 2 or 1. Thus, X or B=4: (YGroup1, AGroup2)=(2,2), (1, [1 or 2]). When (X) and (B) are both equal to 2 slots, YGroup1 may be equal to 1 and AGroup2 may be equal to 2 or 1. Thus, X or B=8: (YGroup1, AGroup2)=(1, [1 or 2]).

Group 1 may support a type 1 common search space (CSS) with dedicated radio resource control (RRC) configuration, a type 3 CSS and/or a UE specific SS. Those skilled in the art will understand that for the above referenced types of SSs, the monitoring occasion (MO) may be configured within the first 3 orthogonal frequency division multiplexing (OFDM) symbols of a slot (e.g., Rel-17) or within a span comprised of appropriate number of OFDM symbols (N) located anywhere within the slot. Thus, a Group 1 SS may refer to a type 1 CSS with dedicated RRC configuration, a type 3 CSS and/or a UE specific SS. As indicated above, these one or more Group 1 SS types may be configured to fall within YGroup1.

Group 2 may support a type 1 CSS without dedicated RRC configuration, a type 0 CSS, a type 0A CSS and/or a type 2 CSS. Those skilled in the art will understand that for the above referenced types of SSs, the MO may be any OFDM symbol of a slot within a span of 3 consecutive OFDM symbols or within a span comprised of any appropriate number of OFMD symbols (e.g., N). Thus, a Group 2 SS may refer to a type 1 CSS without dedicated RRC configuration, a type 0 CSS, a type 0A CSS and/or a type 2 CSS.

Those skilled in the art will also understand that type 1 CSS corresponds to random access, type 0 CSS corresponds to initial access, type 0A CSS corresponds to other system information (OSI) and type 2 CSS corresponds to paging. The location of these types of SSs may correlate to the synchronization signal block (SSB) and thus, the symbol location of the Group 2 SSs may be more complex to control compared to the Group 1 SSs. As will be described in more detail below, the location of Group 1 SS (e.g., YGroup1) may be based on the location of the Group 2 SS (e.g., AGroup2).

The exemplary embodiments are also described with regard to a CORESET. Those skilled in the art will understand that a CORESET may define resource blocks and a number of symbols available to a PDCCH SS set. Thus, a SS set may be mapped to a specific CORESET.

The CORESET may comprise parameters such as, but not limited to, frequency domain resources, a duration (e.g., a number of orthogonal frequency division multiplexing (OFDM) symbols) and a transmission configuration indicator (TCI) state. The TCI state may indicate that a beam is quasi co-located (QCL) to a specific SSB and define a CSS. Thus, the TCI state may indicate the location of one or more SSs relative to the SSB. As will be described in more detail below, the CORESET and its corresponding parameters may be used to configure MSM at the UE 110.

The exemplary embodiments are also described with regard to a SS set. The SS set may use the CORESET to define specific resource blocks and symbols where the UE 110 may attempt to decode PDCCH. The SS set may be based on parameters such as, but not limited to, a CORESET ID, a PDCCH monitoring slot periodicity and offset parameter with reference to a slot with a frame a duration (e.g., a number of slots) over which the SS is valid and a monitoring symbols within a slot parameter. The SS set and its corresponding parameters may be used to configure MSM at the UE 110.

As discussed above, Group 1 SS may include Type 1 CSS with dedicated RRC configuration, Type 3 CSS, and UE-specific SS (USS). The SS is monitored within Y consecutive slots within a slot group of X slots, and the Y consecutive slots can be located anywhere within the slot group of X slots. There is no requirement to align the Y consecutive slots across UEs or with slot no. The location of the Y consecutive slots within the slot group of X slots is maintained across different slot groups. BD attempts for all Group 1 search space sets are restricted to fall within the same Y consecutive slots.

Group 2 SS may include Type 1 CSS without dedicated RRC configuration and Types 0, 0A, and 2 CSS. The SS MOs can be located anywhere within a slot group of X slots, with the exception that BD attempts for Type0-CSS for SSB/CORESET 0 multiplexing pattern 1, and additionally for Type0A/2-CSS if searchSpaceId=0, occur in slots with index no and n0+X0, where X0=4 for 480 kHz SCS and X0=8 for 960 kHz SCS.

In multi-slot PDCCH monitoring, it is possible that monitoring slots between Group 1 (e.g., Group 1 USS) search spaces (SS) and Group 2 (e.g., Group 2 CSS) SS are not aligned. This potential misalignment may be due to the time domain location of Group 2 CSS being determined by the associated SS/PBCH block index, while the MOs of Group 1 USS search spaces are determined by semi-static RRC configuration.

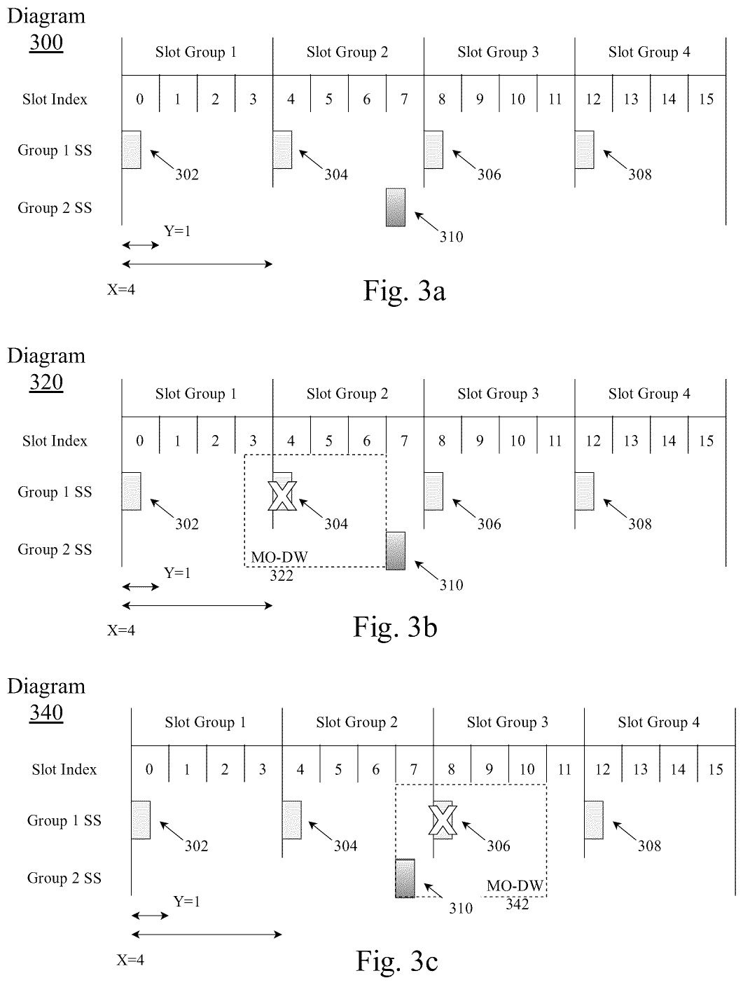

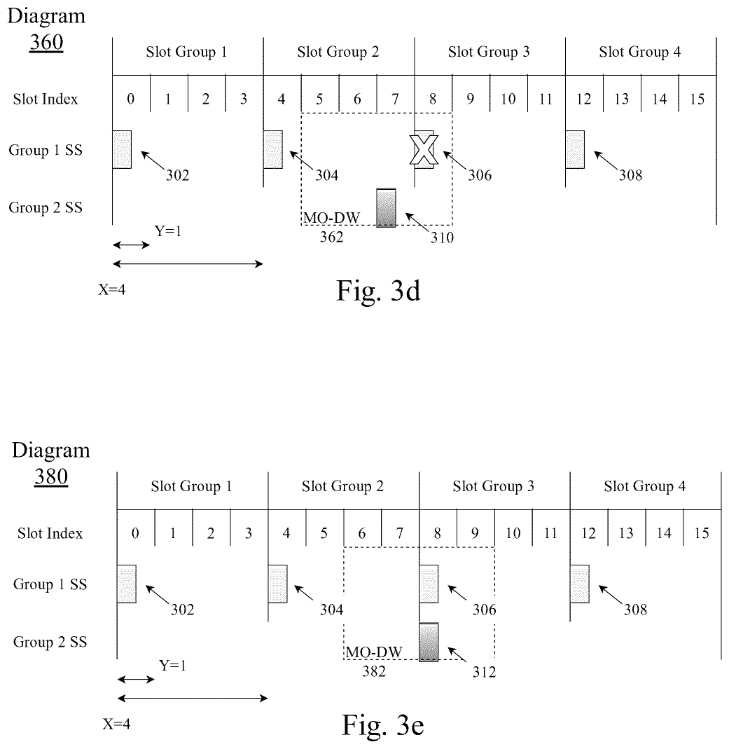

FIG. 3a shows an exemplary diagram 300 of a distribution of monitoring occasions (MOS) for Group 1 SS and Group 2 SS where the monitoring slots are not aligned. In some cases, the PDCCH processing for Group 1 (e.g., USS) and Group 2 (e.g., CSS) may occur in back-to-back slots. As illustrated in FIG. 3a, the slot groups 1-4 comprise X=4 slots where the SS comprises Y=1 slot for both Groups 1 and 2. For Group 1, the MOs for the SS correspond to monitoring slots 0 (MO1 302), 4 (MO2 304), 8 (MO2 306) and 12 (MO4 308). For Group 2, a single MO for the SS corresponds to monitoring slot 7 (MO5 310).

PDCCH MOs dispersed over multiple slots within a slot group may be challenging for some UE implementations and affect power consumption. In the example of FIG. 3a, the period between Group 1 USS MOs in slots 4 and 8 would typically be used by the UE to sleep. The Group 2 CSS MO in slot 7 impedes the power savings and reduced processing achieved by multi-slot PDCCH monitoring by limiting the duration the UE can sleep.

According to certain aspects of the present disclosure, PDCCH MOs can be dropped using a window-based approach. In an exemplary embodiment, the UE determines whether a Group 1 (e.g., Group 1 USS) monitoring occasion (MO) is dropped for PDCCH monitoring. A Group 1 PDCCH MO dropping window (DW) may be defined relative to a given Group 2 PDCCH MO (e.g., Group 2 CSS). The location and duration of the MO-DW, as well as the MO dropping rules for the MO-DW, will be described in detail below.

Various alternatives may be considered for determining the length of the Group 1 MO dropping window (MO-DW) at the UE. In a first alternative, the MO-DW length may be hard-encoded in a specification on a per-SCS basis (e.g., the Third Generation Partnership (3GPP) specifications). In some embodiments, the MO-DW length for a given SCS may be equal to the slot group size for Group 1 USS. For example, the MO-DW length may be 4 for 480 kHz SCS and the MO-DW length may be 8 for 960 kHz SCS. However, this is not required, and the MO-DW may be defined as any length.

In a second alternative, a set of MO-DW lengths may be hard-encoded in a specification. For example, four values may be predefined in the specification to be <n1, n2, n4, n8> as candidate lengths for the MO-DW. The UE may be allowed to select one of the predefined values and report the selected value to the network through a UE capability report. The MO-DW length may be reported on a per-UE basis for each SCS, providing flexibility for UE implementation.

Various options may be considered for the location of the Group 1 MO-DW in the time domain. The starting slot for the Group 1 MO-DW may be defined relative to the Group 2 CSS MO and include a number of slots preceding, including, and/or subsequent to the Group 2 CSS MO.

In a first option, the MO-DW includes a number of slots preceding the Group 2 CSS MO. The first slot of the MO-DW may be defined as, for example, slot n-W, where n is the slot with the Group 2 CSS MO and W is the MO-DW length.

FIG. 3b shows an exemplary diagram 320 of the MOs for Group 1 SS and Group 2 SS of FIG. 3a and a Group 1 MO dropping window (MO-DW) 322 according to the first option of the various exemplary embodiments. Similar to FIG. 3a, for Group 1, the MOs correspond to monitoring slots 0 (MO1 302), 4 (MO2 304), 8 (MO2 306) and 12 (MO4 308) and for Group 2, a single MO corresponds to monitoring slot 7 (MO5 310). The first slot of the MO-DW 322, according to the first option, is defined as n-W, where n=7 and W=4. Thus, the first slot of the MO-DW 322 is slot 3 and the MO-DW 322 spans from slot 3 to slot 6.

The MO-DW 322 defines a window including MO 304 in slot 4. Thus, according to the first option, this MO 304 is dropped. MOS 302, 306 and 308 are not included in the MO-DW 322, and thus these MOs are not dropped.

In a second option, a MO-DW includes a number of slots including and subsequent to the Group 2 CSS MO. The first slot of the MO-DW is defined as the slot n where the Group 2 CSS MO is located.

FIG. 3c shows a diagram 340 of the MOs for Group 1 SS and Group 2 SS of FIG. 3a and an MO-DW 342 according to the second option of the various exemplary embodiments. Similar to FIG. 3a, for Group 1, the MOs correspond to monitoring slots 0 (MO1 302), 4 (MO2 304), 8 (MO2 306) and 12 (MO4 308) and for Group 2, a single MO corresponds to monitoring slot 7 (MO5 310). The first slot of the MO-DW 342, according to the second option, is defined as n, where n=7. Thus, the first slot of the MO-DW 342 is slot 7 and the MO-DW 342 spans from slot 7 to slot 10.

The MO-DW 342 defines a window including MO 306 in slot 8. Thus, according to the second option, this MO 306 is dropped. MOs 302, 304 and 308 are not included in the MO-DW 342, and thus these MOs are not dropped.

It should be understood that the MO-DW may also be defined to include only slots subsequent to, and not including, the Group 2 CSS MO. For example, in the MO distribution described above, the MO-DW could start at slot n+1. As will be described in greater detail below, even when the MO-DW includes the same slot that carries the Group 2 CSS MO, any Group 1 MOs located in the same slot will not be dropped because these MOs are aligned. Thus, in the example of FIG. 3c, the MO-DW 342 spanning from slot 7 to slot 10 that includes the slot of the Group 2 CSS MO (slot 7) is functionally equivalent to an MO-DW that spans from slot 8 to slot 10 (and excludes the slot 7 carrying the Group 2 CSS MO).

In a third option, a MO-DW may include a number of slots preceding, including, and subsequent to the Group 2 CSS MO. The first slot of the MO-DW may be the slot n-K where n is the slot carrying the Group 2 CSS MO and

$$K = ceiling ( \frac{W}{2} ) or K = floor ( \frac{W}{2} ) ,$$

where W is the MO-DW length.

FIG. 3d shows a diagram 360 of the MOs for Group 1 SS and Group 2 SS of FIG. 3a and an MO-DW 362 according to the third option of the various exemplary embodiments. Similar to FIG. 3a, for Group 1, the MOs correspond to monitoring slots 0 (MO1 302), 4 (MO2 304), 8 (MO2 306) and 12 (MO4 308) and for Group 2, a single MO corresponds to monitoring slot 7 (MO5 310). The first slot of the MO-DW 362, according to the third option, is defined as n-K, where n=7 and K=W/2, where W=4 and K=2. Thus, the first slot of the MO-DW 362 is slot 5 and the MO-DW 362 spans from slot 5 to slot 8.

Similar to the MO-DW 342 of FIG. 3b, the MO-DW 362 defines a window including MO 306 in slot 8. Thus, according to the third option, this MO 306 is dropped. MOs 302, 304 and 308 are not included in the MO-DW 362, and thus these MOs are not dropped.

Similar to FIG. 3b described above, even when the MO-DW includes the same slot that carries the Group 2 CSS MO, any Group 1 MOs located in the same slot will not be dropped, because these MOs are aligned with Group 2 CSS MO. Thus, in the example of FIG. 3d, the MO-DW 362 spanning from slot 5 to slot 9 that includes the slot of the Group 2 CSS MO (slot 7) is functionally equivalent to a split MO-DW that includes slots 5-6 and 8 (and excludes the slot 7 carrying the Group 2 CSS MO).

FIG. 3e shows a diagram 380 comprising an MO distribution for Group 1 SS and Group 2 SS where a Group 2 MO is located in the same slot as a Group 1 MO. Similar to FIG. 3a, for Group 1, the Group 1 MOs correspond to a number of symbols for monitoring slots 0 (MO1 302), 4 (MO2 304), 8 (MO2 306) and 12 (MO4 308). However, contrary to FIG. 3a, the Group 2 MOs include an MO in monitoring slot 8 (MO6 312), instead of slot 7. Using the third option discussed above, the first slot of the MO-DW 382 is slot 6 and the MO-DW 382 spans from slot 6 to slot 9.

The MO-DW 382 defines a window including MO 306 in slot 8. However, because the Group 2 CSS PDCCH MO falls within the Ygroup1 slots, the Group 1 USS PDCCH MOs in the MO-DW associated with the Group 2 CSS PDCCH MO is not skipped. Thus, no Mos are dropped.

In one embodiment, the UE drops USS PDCCH MOs across all component carriers (CCs) according to the window-based approach described above. In another embodiment, the UE drops USS PDCCH MOs only on the Primary Cell (PCell) or the Primary Secondary Cell (PSCell) where the CSS is located.

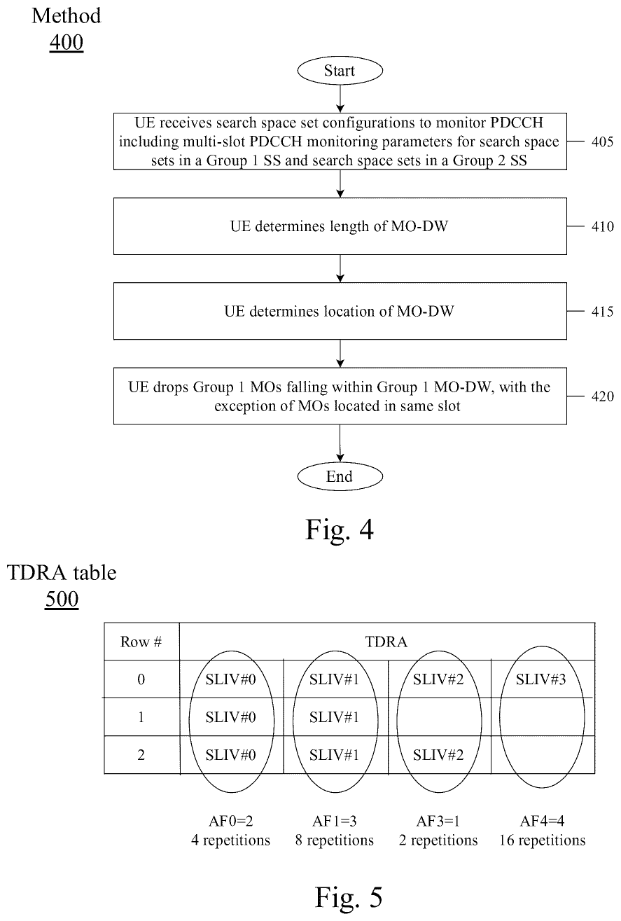

FIG. 4 shows a method 400 for dropping PDCCH MOS according to various exemplary embodiments.

In 405, the UE receives search space set configurations to monitor PDCCH from the network including multi-slot PDCCH monitoring parameters for search space sets in a Group 1 SS and search space sets in a Group 2 SS. As discussed above, the UE may be configured with a PDCCH that includes multiple subframes and with a SCS of e.g., 480 or 960 KHz. The UE may be further configured with slot groups of size X (e.g., X=4) slots and for performing PDCCH monitoring in Y consecutive slots (e.g., Y=1) from each of the slot groups. During slots where a PDCCH MO is not scheduled, the UE has the opportunity to sleep and conserve power. In some scenarios, a Group 2 CSS MO may be located in a slot that is not aligned with the slot in which a Group 1 USS MO is located, due to the time domain location of Group 2 CSS being determined by the associated SS/PBCH block index (or any other reason), while the MOs of Group 1 USS search spaces are determined by semi-static RRC configuration.

In 410, the UE determines the length of a MO dropping window (MO-DW). As discussed above, this length can be hard-encoded in UE specification on a per-SCS basis. The length may comprise a single value, or multiple values can be available to the UE for selection. If multiple values are available, the UE can report the selected value to the base station.

In 415, the UE determines the location of the MO-DW in the time domain. As discussed above, the MO-DW location is determined relative to a Group 2 CSS MO and multiple different options can be used to determine the starting slot of the MO-DW. The starting slot can be defined so that the MO-DW precedes the slot of the associated Group 2 CSS MO, starts from the slot of the associated Group 2 CSS MO, and/or is subsequent to the slot of the associated Group 2 CSS MO.

In 420, the UE drops Group 1 MOs that fall within the MO-DW, with the exception of Group 1 MOs located in the same slot as the Group 2 MO. In some embodiments, Group 1 MOs are dropped across all CCs, while in other embodiments, Group 1 MOS are dropped only on the PCell or the PSCell of the CSS.

According to further aspects of these exemplary embodiments, in the increased frequency range (>52.6 GHZ), multiple uplink (UL) (PUSCH) and/or downlink (DL) (PDSCH) may be scheduled in a single period of the configured UL/DL grant. For example, with respect to the slot group arrangement described above for PDCCH monitoring, it may be desirable to schedule UL/DL transmissions across slots of the slot group even when a PDCCH is transmitted in only one of the slots.

In NR operation between 52.6 GHz and 71 GHZ, the following features may be supported for scheduling multi-PDSCH/PUSCH (referred to jointly hereinafter as “PxSCH”) with a single DCI. For a UE and for a serving cell, multiple PDSCHs may be scheduled by a single DL DCI and multiple PUSCHs may be scheduled by a single UL DCI, for example PxSCHs having an SCS of 120 kHz, 480 kHz and 960 kHz. DCI format 0_1 may be used to schedule multiple PUSCHs with a single DCI and DCI format 1_1 may be used to schedule multiple PDSCHs with a single DCI (DCI formats 0_1 and 1_1 being referred to jointly hereinafter as “DCI format x_1”). Each PxSCH may have individual/separate TB(s), and each PxSCH may be confined within a slot. For a DCI that can schedule multiple PxSCHs, a time domain resource allocation (TDRA) table may be extended such that each row indicates up to 8 multiple PxSCHs (that can be non-continuous in the time-domain). Each PxSCH may have a separate start and length indicator value (SLIV) and mapping type. The number of scheduled PxSCHs may be implicitly indicated by the number of indicated valid SLIVs in the row of the TDRA table signaled in DCI. This does not preclude continuous resource allocation in the time-domain.

The multiple PxSCH may be configured by the network via RRC signaling using a PxSCH configuration message, e.g., an ASN.1 message carried in DCI Format x_1, which may include parameters for periodicity, HARQ processes, MCS, aggregation factor (pxsch-AggregationFactor), and/or redundancy version (RV), to name a few. The parameter pxsch-AggregationFactor generally relates to a number of repetitions to use for different TBs. A UE can be configured with PxSCH repetition, where a single PxSCH is repeated across consecutive slots. Repetitions help to improve the reliability and reduce latency compared to dynamic HARQ retransmission. The parameter “pdsch-AggregationFactor” may provide the number of transmissions to be applied to the TB. For multi-PxSCH scheduling, support of repetition is attractive and useful to improve the PxSCH performance.

According to certain aspects of the present disclosure, a variety of approaches can be considered for resource allocation in the time domain for a UE enabled with multi-PxSCH scheduling. When the UE is configured with a TDRA table for multi-PxSCH scheduling, where one or more rows contain multiple SLIVs for PxSCH, the following alternatives may be considered with respect to PxSCH repetition.

In a first alternative, simultaneous configuration of multi-PxSCH and repetition is not allowed and the UE does not expect to be configured with PxSCH repetition in the multi-PxSCH configuration message. In other words, the PxSCH-AggregationFactor IE is not allowed to be used in a multi-PxSCH configuration ASN.1 message for DCI Format x 1. This alternative is simple but at the cost of scheduling restrictions.

In a second alternative, a PxSCH repetition parameter R is configured by RRC signaling and the R parameter may be applied for all the TDRA rows in the RRC-configured table. However, the repetitions are applied only when the PxSCH configuration, which contains ‘K’ SLIVs for PxSCH satisfies K≤N. In one option, the value of ‘N’ may be explicitly configured by RRC signaling in the PxSCH configuration message. In a second option, the value of ‘N’ may be implicitly determined as

$$N = floor ( \frac{{K}_{max}}{R} ) ,$$

where Kₘₐₓ is the maximum number of SLIVs across all rows in the RRC-configured TDRA table and R is the PxSCH repetition number that is configured by RRC signaling. In a third option, the value of ‘N’ may be hard-encoded in a specification e.g., N=1. The third option supports a ‘fallback’ operation to single PxSCH with enabling repetition transmission.

In a third alternative, for each SLIV in a row of an RRC-configured TDRA Table, the number of PxSCH transmission occasions for slot-based repetition may be explicitly configured by RRC signaling. Table 1 shows a TDRA table for multi-PxSCH constructed with a row with four aggregated TDRAs. As shown, each SLIV has an associated repetition number R, e.g., SLIV #0 is associated with R0, SLIV #1 is associated with R1, etc.

TABLE 1

| Row | | | | | | | | |
|---|---|---|---|---|---|---|---|---|
| index | TDRA #0 | | TDRA #1 | | TDRA #2 | | TDRA #3 | |
| 0 | SLIV | Repetition | SLIV | Repetition | SLIV | Repetition | SLIV | Repetition |
| | | Num | | Num | | Num | | Num |
| | SLIV#0 | R0 | SLIV#1 | R1 | SLIV#2 | R2 | SLIV#3 | R3 |

In a fourth alternative, the UE may be configured with a list of PxSCH-AggregationFactor as (AF₀, AF₁, . . . , AF_{R-1}), wherein AF₀ is commonly applied for the SLIV #0 in each TDRA row; AF₁ is commonly applied for the SLIV #1 in each TDRA row; AF₂ is commonly applied for the SLIV #2 in each TDRA row; etc., as shown in FIG. 5 described below.

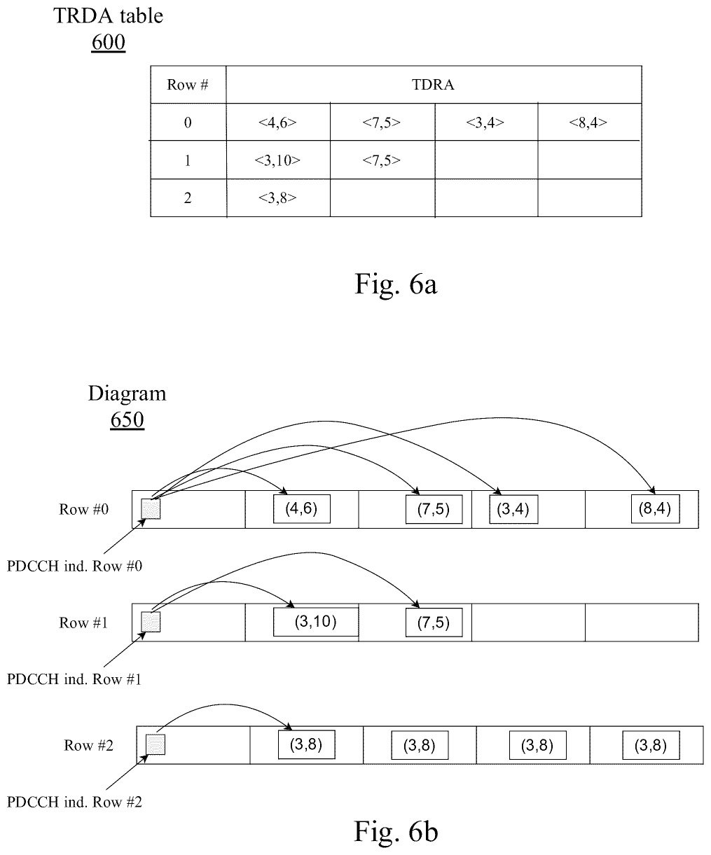

FIG. 5 shows an exemplary TDRA table 500 and associated repetitions to be applied to each table entry. As illustrated in FIG. 6, the TDRA table 600 comprises three rows (0, 1, 2), wherein row 0 comprises four table entries SLIV #0, SLIV #1, SLIV #2 and SLIV #3, row 1 comprises two table entries SLIV #0 and SLIV #1, and row 2 comprises three table entries SLIV #0, SLIV #1 and SLIV #2. In this example, the UE is configured with a list of PxSCH-AggregationFactor (AF₀, AF₁, . . . , AF_{R-1}) as (2,3,1,4).

In accordance with the fourth alternative discussed above, AF₀=2 (4 repetitions) is applied for the SLIV #0 across the TDRA rows (rows 0, 1, 2), AF₁=3 (8 repetitions) is applied for the SLIV #1 across the TDRA rows (rows 0, 1, 2), AF₂=1 (1 repetition) is applied for the SLIV #1 across the TDRA rows (rows 0, 2), and AF₃=4 (16 repetitions) is applied for the SLIV #1 across the TDRA rows (row 0).

In a fifth alternative, the repetition number may be signaled in the scheduling DCI by introducing a new field. In some designs, a set of repetition numbers may be first configured by RRC signaling, after which the codepoint of repetition number indicator field is used to dynamically indicate the repetition number in the scheduling DCI (scheduling DCI Format).

In a sixth alternative, the repetition number may be carried by the selection of a scrambling sequence to scramble the CRC bits of the scheduling DCI Format. In some designs, assuming repetition numbers are configured by RRC as (1,2), the exact repetition for a given multi-PxSCH scheduling may be indicated using the corresponding scrambling sequence as shown below in Table 2.

TABLE 2

| Index of Repetition number | [w₀, w₁, . . . , w₂₃] |
|---|---|
| 0 | <0, 0, 0, . . . 0> |
| 1 | <1, 1, 1, . . . 1> |

When receiving PXSCH scheduled by DCI format X_1, if the UE is configured with PxSCH-AggregationFactor in PxSCHconfig, each SLIV in the indicated row of TDRA able is applied across the pdsch-AggregationFactor consecutive slots. In some designs, the starting slot Kᵢ for the i-th SLIV (i=0, . . . ) in the indicated row is determined as Kᵢ=n+K+i*R, where n is the slot with the scheduling DCI, K is K₀ for multi-PDSCH and K₂ for multi-PUSCH that is configured by RRC for each TDRA row.

In one specific example, referring to the second alternative (third option) discussed above wherein the value of N is hard-encoded in specification as N=1, a single PxSCH can be enabled for repetition.

FIG. 6a shows an exemplary TDRA table 600 comprising three rows, wherein Row #0 includes 4 SLIVs, Row #1 includes 2 SLIVs, and Row #2 includes 1 SLIV. In this example, the repetition number configured by RRC signaling is R=4.

Using the above-described option, repetition does not occur (is disabled) when Rows #0 or #1 are indicated by the TDRA field in scheduling DCI Format because the number of SLIVs in these rows exceeds N. However, repetition does occur when Row #2 is indicated by the TDRA field in scheduling DCI Format i.e., single PxSCH transmission.

FIG. 6b shows an exemplary diagram 650 of the repetition behavior for the SLIVs of the TDRA table of FIG. 6a. As shown, the PDSCH for Rows #0 and #1 are not subject to repetition, while the PDSCH for Row #2 is subject to repetition in accordance with R=4

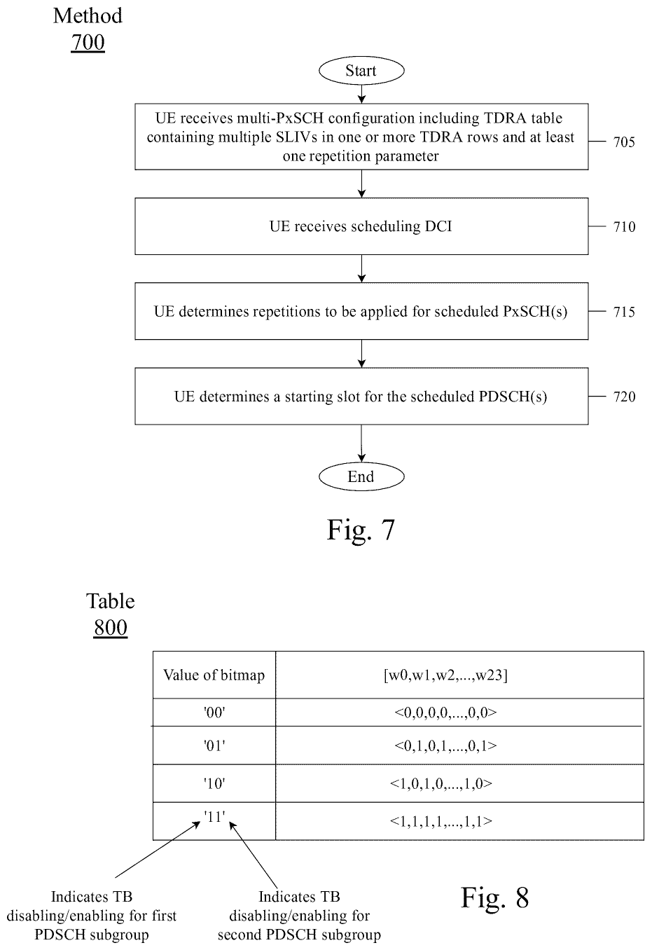

FIG. 7 shows a method 700 for multi-PDSCH/PUSCH (PxSCH) repetition according to various exemplary embodiments.

In 705, the UE receives an RRC configuration for multi-PxSCH. The RRC configuration may include a TDRA table comprising one or more rows containing multiple SLIVs for the multiple PxSCHs. According to various embodiments, the RRC configuration may further include a single R parameter for repetitions that can be applied across all rows and SLIVs and an associated N parameter; multiple R parameters, each associated with a particular SLIV; a list of PxSCH AggregationFactor parameters (AF₀, AF₁, . . . , AF_{R-1}), wherein each AF parameter is applied for a given SLIV # in each row of the TDRA table; or a new field carrying a repetition number or a set of repetition numbers.

In 710, the UE receives a scheduling DCI indicating one or more rows of the TDRA table for scheduling PxSCH. According to one embodiment, the scheduling DCI can further include a repetition number indicator field for dynamically indicating a repetition number from a set of configured repetition numbers. According to another embodiment, the scrambling sequence selected to scramble the CRC bits of the scheduling DCI can be used to indicate a repetition number from a set of configured repetition numbers.

In 715, the UE determines the repetitions to be applied for each of the scheduled PxSCHs. According to various embodiments, the UE can apply R repetitions to each of the SLIVs in each of the scheduled rows, based on the K SLIVs in the row being less than or equal to a determined N value; the UE can apply Rᵢ repetitions for each SLIV having an associated R value; the UE can apply repetitions based on a configured list of AggregationFactor; the UE can apply a repetition number signaled in a new DCI field and, in one embodiment, indicated from a set of configured repetition numbers; or the UE can apply a repetition number based on the scrambling sequence of the scheduling DCI.

In 720, the UE determines a starting slot Kᵢ for the i-th SLIV (i=0, . . . ) in the indicated row from Kᵢ=n+K+i*R, where n is the slot with the scheduling DCI, K is K₀ for multi-PDSCH and K₂ for multi-PUSCH that is configured by RRC for each TDRA row.

According to further aspects of the present disclosure, techniques for transport block (TB) disabling for multi-PDSCH scheduling are considered. Each PDSCH in multi-PDSCH scheduling is assigned with a 1-bit RV and each PDSCH may consist of one or two TBs.

In previous techniques, one of 2 TBs is disabled by DCI format 1_1 with MCS=26 and RV index #1 for the corresponding transport block. However, if the scheduled PDSCH in a multi-PDSCH configuration is larger than 1, each PDSCH has only a 1-bit RV field. As a consequence, the legacy mechanism for TB-disabling is not sufficient for multi-PDSCH, since only one redundancy version (RV) bit is allocated for each PDSCH and the bit indicates RV index #0 or index #2, instead of RV index #1.

According to certain aspects of the present disclosure, a variety of approaches may be considered to support the TB-disabling function for multi-PDSCH operation when more than one PDSCH is scheduled.

In a first alternative, a predefined value may be hard-encoded in specification for the M-bit RV field, e.g., all ‘1’, where M is the maximum number of SLIVs for multi-PDSCH scheduling. This predefined RV vector (e.g., all ‘1’) is used to indicate the 2nd TB for all the scheduled PDSCHs is disabled.

In other designs, other candidates for hard-encoded vector values may include (0,1, 0,1,0,1 . . . ) or (1, 0,1, 0, 1, 0 . . . ). This design is simple and technically feasible, considering the time-domain channel correlation across short slots with new 480 kHz/960 KHz SCSs. However, these designs pose a stringent scheduling restriction at the network side. The throughput performance of multi-PDSCH may be degraded if the enabling/disabling of the second TB is operated on a per multi-PDSCH scheduling DCI basis.

In a second alternative, a PDSCH subgroup-based bitmap indication is used. In a first step, the ‘M’ PDSCHs scheduled by a single DCI are divided into ‘K’ PDSCH sub-groups. To divide the PDSCHs into subgroups, M1 is defined as

$${M}_{1} = mod ( M , K ) , {L}_{1} = ceiling ( \frac{M}{K} ) , {L}_{2} = floor ( \frac{M}{K} ) .$$

If M₁>0, the PDSCH sub-group m, m=0, 1, . . . , M₁−1, comprises PDSCHs with indices m*L₁+l,l=0, 1, . . . , L₁−1. PDSCH sub-group m, m=M₁, M₁+1, . . . , K−1 consists of PDSCH with indices M₁*L₁+(m−M₁)*L₂+l,l=0, 1, . . . , L₂−1.

In a second step, a K-bit bitmap is introduced, where each bit is used to indicate the TB-disabling for the second TB of PDSCHs in a dedicated PDSCH subgroup.

In a third step, the bitmap is indicated by selection of a scrambling sequence [w₀, w₁, . . . , w₂₃] to scramble the CRC bits of the scheduling DCI Format.

FIG. 8 shows an exemplary table 800 for indicating the enabling/disabling of transport blocks (TBs) in multi-PDSCH scheduling according to various exemplary embodiments. In the example of FIG. 8, the K value is 2, e.g., two sub-groups are used. A set of four possible scrambling sequences is shown on the right side of the table, wherein each scrambling sequence is associated with a different 2-bit bitmap. The first bit of the 2-bit bitmap indicates the TB-disabling/enabling for the second TB of the PDSCHs in the first PDSCH sub-group, while the second bit of the 2-bit bitmap indicates the TB-disabling/enabling for the second TB in the second PDSCH sub-group.

In a third alternative, the RV value of ‘1’ in the scheduling DCI is redefined to indicate RV index #1. As discussed above, in previous techniques, the value of the RV field can indicate RV index #0 (RV value of 0) or RV index #2 (RV value of 1). In the third alternative, the RV index #1 can be indicated by the RV value of 1, and the RV index #2 cannot be indicated in this field.

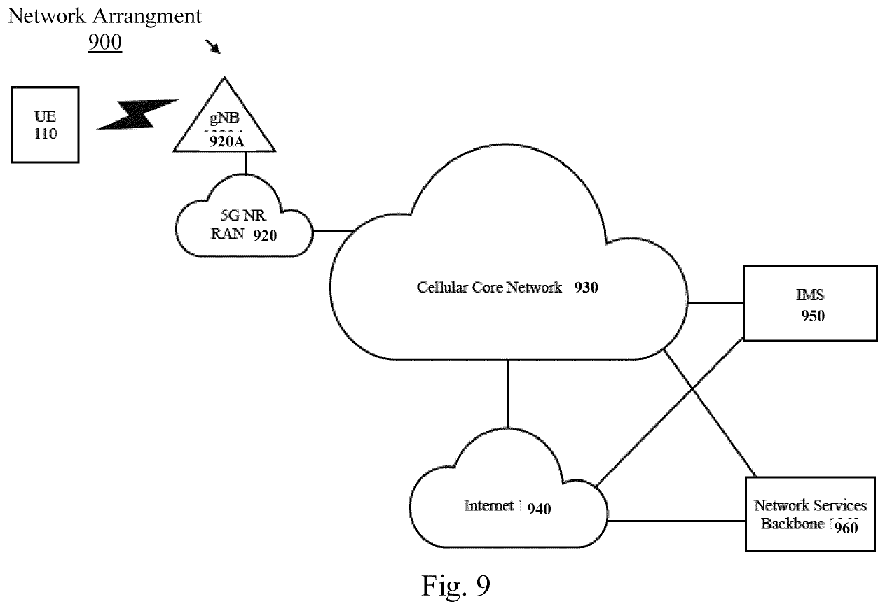

FIG. 9 shows an exemplary network arrangement 900 according to various exemplary embodiments. The exemplary network arrangement 900 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 900, the network with which the UE 110 may wirelessly communicate is a 5G NR radio access network (RAN) 920. However, the UE 110 may also communicate with other types of networks (e.g., 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 920. Therefore, the UE 110 may have a 5G NR chipset to communicate with the 5G NR RAN 920.

The 5G NR RAN 920 may be a portion of a cellular network that may be deployed by a network carrier (e.g., Verizon, AT&T, T-Mobile, etc.). The 5G NR RAN 920 may include, for example, nodes, cells or base stations (e.g., Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR-RAN 920. For example, as discussed above, the 5G NR-RAN 920 may be associated with a particular cellular provider where the UE 110 and/or the user thereof has a contract and credential information (e.g., stored on a SIM card). Upon detecting the presence of the 5G NR-RAN 920, the UE 110 may transmit the corresponding credential information to associate with the 5G NR-RAN 920. More specifically, the UE 110 may associate with a specific base station, e.g., the next generation Node B (gNB) 920A.

The network arrangement 900 also includes a cellular core network 930, the Internet 940, an IP Multimedia Subsystem (IMS) 950, and a network services backbone 960. The cellular core network 930 may refer an interconnected set of components that manages the operation and traffic of the cellular network. It may include the evolved packet core (EPC) and/or the fifth generation core (5GC). The cellular core network 930 also manages the traffic that flows between the cellular network and the Internet 940. The IMS 950 may be generally described as an architecture for delivering multimedia services to the UE 110 using the IP protocol. The IMS 950 may communicate with the cellular core network 930 and the Internet 940 to provide the multimedia services to the UE 110. The network services backbone 960 is in communication either directly or indirectly with the Internet 940 and the cellular core network 930. The network services backbone 960 may be generally described as a set of components (e.g., servers, network storage arrangements, etc.) that implement a suite of services that may be used to extend the functionalities of the UE 110 in communication with the various networks.

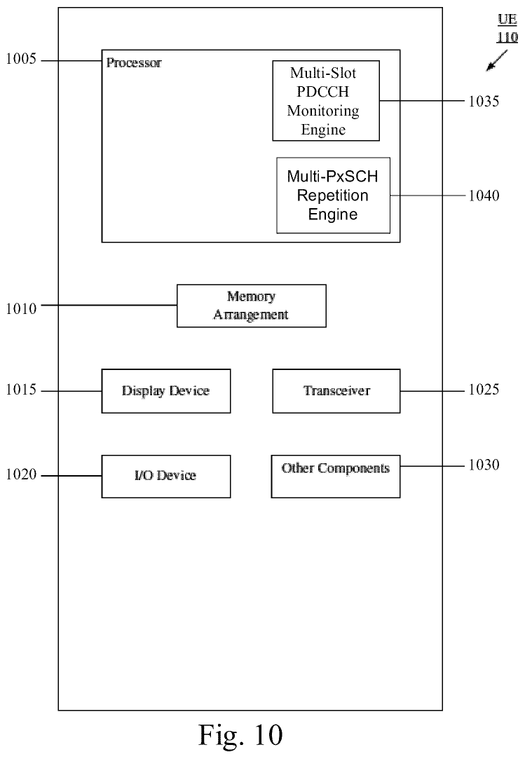

FIG. 10 shows an exemplary UE 110 according to various exemplary embodiments. The UE 110 will be described with regard to the network arrangement 900 of FIG. 9. The UE 110 may include a processor 1005, a memory arrangement 1010, a display device 1015, an input/output (I/O) device 1020, a transceiver 1025 and other components 1030. The other components 1030 may include, for example, an audio input device, an audio output device, a power supply, a data acquisition device, ports to electrically connect the UE 110 to other electronic devices, etc.

The processor 1005 may be configured to execute a plurality of engines of the UE 110. For example, the engines may include a multi-slot PDCCH monitoring engine 1035. The multi-slot PDCCH monitoring engine 1035 may perform various operations related to the exemplary techniques described above including, but not limited to, receiving a multi-slot PDCCH monitoring configuration and determining which MOs to drop when MOs across SS Groups are not aligned. The engines may further include a multi-PxSCH repetition engine 1040. The multi-PxSCH repetition engine 1040 may perform various operations related to the exemplary techniques described above including, but not limited to, receiving a multi-PxSCH configuration and determining a number of repetitions to apply to a particular PxSCH.

The above referenced engines 1035, 1040 being an application (e.g., a program) executed by the processor 1005 is merely provided for illustrative purposes. The functionality associated with the engine 1035 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 1005 is split among two or more processors such as a baseband processor and an applications processor. The exemplary embodiments may be implemented in any of these or other configurations of a UE.

The memory arrangement 1010 may be a hardware component configured to store data related to operations performed by the UE 110. The display device 1015 may be a hardware component configured to show data to a user while the I/O device 1020 may be a hardware component that enables the user to enter inputs. The display device 1015 and the I/O device 1020 may be separate components or integrated together such as a touchscreen. The transceiver 1025 may be a hardware component configured to establish a connection with the 5G NR-RAN 920, an LTE-RAN (not pictured), a legacy RAN (not pictured), a WLAN (not pictured), etc. Accordingly, the transceiver 1025 may operate on a variety of different frequencies or channels (e.g., set of consecutive frequencies).

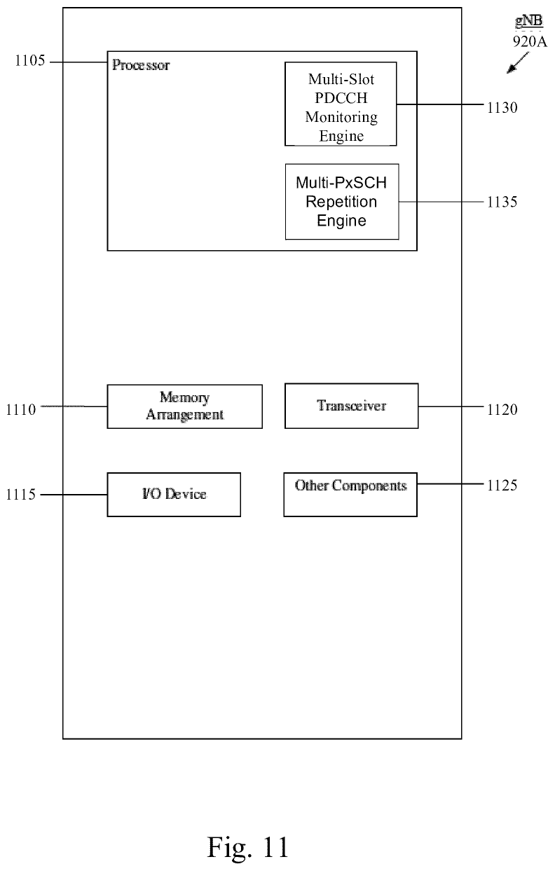

FIG. 11 shows an exemplary base station 1100 according to various exemplary embodiments. The base station 1100 may represent the gNB 920A or any other access node through which the UE 110 may establish a connection and manage network operations.

The base station 1100 may include a processor 1105, a memory arrangement 1110, an input/output (I/O) device 1115, a transceiver 1120, and other components 1125. The other components 1125 may include, for example, an audio input device, an audio output device, a battery, a data acquisition device, ports to electrically connect the base station 1100 to other electronic devices, etc.

The processor 1105 may be configured to execute a plurality of engines for the base station 1100. For example, the engines may include a multi-slot PDCCH monitoring engine 1130. The multi-slot PDCCH monitoring engine 1130 may perform various operations related to the exemplary techniques described above including, but not limited to, transmitting a multi-slot PDCCH monitoring configuration. The engines may further include a multi-PxSCH repetition engine 1135. The multi-PxSCH repetition engine 1135 may perform various operations related to the exemplary techniques described above including, but not limited to, transmitting a multi-PxSCH configuration including an indication of a number of repetitions to apply to a particular PxSCH.

The above noted engine 1130 being an application (e.g., a program) executed by the processor 1105 is only exemplary. The functionality associated with the engine 1130 may also be represented as a separate incorporated component of the base station 1100 or may be a modular component coupled to the base station 1100, e.g., an integrated circuit with or without firmware. For example, the integrated circuit may include input circuitry to receive signals and processing circuitry to process the signals and other information. In addition, in some base stations, the functionality described for the processor 1105 is split among a plurality of processors (e.g., a baseband processor, an applications processor, etc.). The exemplary embodiments may be implemented in any of these or other configurations of a base station.

The memory 1110 may be a hardware component configured to store data related to operations performed by the base station 1100. The I/O device 1115 may be a hardware component or ports that enable a user to interact with the base station 1100. The transceiver 1120 may be a hardware component configured to exchange data with the UE 110 and any other UE in the network arrangement 900. The transceiver 1120 may operate on a variety of different frequencies or channels (e.g., set of consecutive frequencies). Therefore, the transceiver 1120 may include one or more components (e.g., radios) to enable the data exchange with the various networks and UEs.

### EXAMPLES

In a first example, a user equipment (UE) comprises a transceiver configured to communicate with a network and a processor communicatively coupled to the transceiver and configured to perform operations comprising receiving, from the network, search space set configurations to monitor physical downlink control channel (PDCCH) including multi-slot PDCCH monitoring parameters for search space sets in a first search space (SS) group and search space sets in a second SS group, the multi-slot PDCCH monitoring parameters including a number of slots X included in a slot group and a number of slots Y used for monitoring the first search space groups in a slot group, determining a length and a location of a monitoring occasion (MO) dropping window (MO-DW) based on a location of a second SS group MO and dropping one or more first SS group MOs that fall within the MO-DW.

In a second example, the UE of the first example, wherein the MO-DW includes slots preceding the second SS group MO.

In a third example, the UE of the second example, wherein a first slot of the MO-DW is defined as n-W, where n is a slot carrying the second SS group MO and W is the MO-DW length.

In a fourth example, the UE of the first example, wherein the MO-DW includes slots subsequent to the second SS group MO.

In a fifth example, the UE of the fourth example, wherein a first slot of the MO-DW is defined as n, where n is a slot carrying the second SS group MO.

In a sixth example, the UE of the first example, wherein the MO-DW includes slots preceding and subsequent to the second SS group MO.

In a seventh example, the UE of the sixth example, wherein a first slot of the MO-DW is defined as n-K, where n is a slot carrying the second SS group MO and K is defined relative to the MO-DW length.

In an eighth example, the UE of the first example, wherein the length of the MO-DW is predefined in specification on a per-subcarrier spacing (SCS) basis.

In a ninth example, the UE of the first example, wherein the length of the MO-DW is equal to the number of slots X included in the slot group.

In a tenth example, the UE of the first example, wherein the operations further comprise selecting, by the UE, the length of the MO-DW from a set of MO-DW lengths predefined in specification and reporting, by the UE, the selected MO-DW length to the network.

In an eleventh example, the UE of the first example, wherein the first SS group MOs that fall within the MO-DW are dropped across all component carriers.

In a twelfth example, the UE of the first example, wherein the first SS group MOs that fall within the MO-DW are dropped on a primary cell (PCell) or primary secondary cell (PSCell) where the second SS group MO is located.

In a thirteenth example, a user equipment (UE) comprises a transceiver configured to communicate with a network and a processor communicatively coupled to the transceiver and configured to perform operations comprising receiving a PxSCH configuration, wherein PxSCH represents a physical downlink shared channel (PDSCH) or a physical uplink shared channel (PUSCH), the PxSCH configuration including a time domain resource allocation (TDRA) table comprising one or more rows with at least one row containing multiple starting length and indicator values (SLIVs) and at least one repetition parameter, receiving a scheduling downlink control information (DCI) indicating one or more rows of the TDRA table and determining a number of repetitions to apply to PxSCH transmissions based on the at least one repetition parameter.

In a fourteenth example, the UE of the thirteenth example, wherein the at least one repetition parameter includes an R parameter that is applied to the SLIVs in an indicated row of the TDRA table when a number of SLIVs K in the row is less than or equal to a value of N.

In a fifteenth example, the UE of the fourteenth example, wherein the value of N is explicitly configured via radio resource control (RRC) signaling in the PxSCH configuration, the value of N is implicitly determined as N=floor (Kₘₐₓ/R), where Kₘₐₓ is a maximum number of SLIVs across all rows of the TDRA table, or the value of N is hard-encoded in specification.

In a sixteenth example, the UE of the thirteenth example, wherein the at least one repetition parameter includes a respective R parameter for each SLIV in a row of the TDRA table.

In a seventeenth example, the UE of the thirteenth example, wherein the at least one repetition parameter includes a list of AggregationFactor (AF) parameters, wherein a given AF parameter is commonly applied for SLIVs having a same SLIV index number across rows of the TDRA table.

In an eighteenth example, the UE of the thirteenth example, wherein the at least one repetition parameter is provided in a new information field in the scheduling DCI.

In a nineteenth example, the UE of the eighteenth example, wherein a set of repetition numbers are configured in the PxSCH configuration by RRC signaling and the scheduling DCI indicates one repetition number from the set of RRC-configured repetition numbers in a repetition number indicator field.

In a twentieth example, the UE of the thirteenth example, wherein at least two predefined repetition numbers are configured in the PxSCH configuration by RRC signaling, wherein a value for one of the predefined repetition numbers is indicated based on a scrambling sequence selected from a set of predefined sequences and used for scrambling the cyclic redundancy check (CRC) bits of the scheduling DCI.

In a twenty first example, the UE of the twentieth example, wherein the set of predefined sequences includes two scrambling sequences [w₀, w₁ . . . w₂₃] of all zeros (wᵢ=0, i=0, . . . , 23) and all ones (wᵢ=1, i=0, . . . , 23), where each scrambling sequence is used to indicate one of two predefined values for the repetition parameter.

In a twenty second example, the UE of the thirteenth example, wherein a starting slot Kᵢ for a given SLIV i in the indicated row is determined by Kᵢ=n+K+i*R, where n is a slot of the scheduling DCI, K is K₀ for multi-PDSCH and K₂ for multi-PUSCH.

In a twenty third example, the UE of the thirteenth example, wherein the UE does not expect to simultaneously receive, in the PxSCH configuration, both the TDRA table comprising one or more rows with at least one row containing multiple SLIVs and the at least one repetition parameter.

In a twenty fourth example, the UE of the thirteenth example, wherein the operations further comprise receiving, in the PxSCH configuration, a parameter indicating a second transport block for the PxSCH transmissions or receptions is disabled.

In a twenty fifth example, the UE of the twenty fourth example, wherein the parameter comprises a M-bit redundancy version (RV) field, wherein, when a value of the M-bit RV field matches a predefined value hard-encoded in specification, the UE determines the second transport block for the PxSCH transmissions or receptions should be disabled.

In a twenty sixth example, the UE of the thirteenth example, wherein M PDSCHs scheduled by the scheduling DCI are divided into K subgroups, wherein the operations further comprise receiving an indication of enabling or disabling the second transport blocks (TBs) based on a scrambling sequence used for scrambling the cyclic redundancy check (CRC) bits of the scheduling DCI.

In a twenty seventh example, the UE of the twenty sixth example, wherein the indication of enabling or disabling the second TBs based on the scrambling sequence further comprises predefining a set of scrambling sequences in specification, wherein each scrambling sequence is one-to-one associated with a value of the K-bit bitmap with each bit indicating the second TB enabling or disabling for one of the K subgroups and determining, by the UE, the enabling or disabling the second TBs based on the sequence used for scrambling the CRC bits of the scheduling DCI.

In a twenty eighth example, the UE of the thirteenth example, wherein the operations further comprise predefining a 1-bit redundancy version (RV) field in the DCI scheduling multiple PxSCHs to be a value of ‘0’ indicating value ‘rv_{id}=0’ and a value of ‘1’ indicating value ‘rv_{id}=1’ and receiving, in the scheduling DCI, a value of ‘1’ in the 1-bit RV field to disable a second transport block.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
receiving, from a network, search space set configurations to monitor physical downlink control channel (PDCCH) including multi-slot PDCCH monitoring parameters for search space sets in a first search space (SS) group and search space sets in a second SS group, the multi-slot PDCCH monitoring parameters including a number of slots X included in a slot group and a number of slots Y used for monitoring the first search space groups in a slot group;
determining a length and a location of a monitoring occasion (MO) dropping window (MO-DW) based on a location of a second SS group MO; and
dropping one or more first SS group MOs that fall within the MO-DW.

2. The processor of claim 1, wherein the MO-DW includes slots preceding the second SS group MO.

3. The processor of claim 2, wherein a first slot of the MO-DW is defined as n-W, where n is a slot carrying the second SS group MO and W is the MO-DW length.

4. The processor of claim 1, wherein the MO-DW includes slots subsequent to the second SS group MO.

5. The processor of claim 4, wherein a first slot of the MO-DW is defined as n, where n is a slot carrying the second SS group MO.

6. The processor of claim 1, wherein the MO-DW includes slots preceding and subsequent to the second SS group MO.

7. The processor of claim 6, wherein a first slot of the MO-DW is defined as n-K, where n is a slot carrying the second SS group MO and K is defined relative to the MO-DW length.

8. The processor of claim 1, wherein the length of the MO-DW is predefined in specification on a per-subcarrier spacing (SCS) basis or is equal to the number of slots X included in the slot group.

9. (canceled)

10. The processor of claim 1, wherein the operations further comprise:
selecting, by the UE, the length of the MO-DW from a set of MO-DW lengths predefined in specification; and
reporting, by the UE, the selected MO-DW length to the network.

11. The processor of claim 1, wherein the first SS group MOs that fall within the MO-DW are dropped across all component carriers.

12. The processor of claim 1, wherein the first SS group MOs that fall within the MO-DW are dropped on a primary cell (PCell) or primary secondary cell (PSCell) where the second SS group MO is located.

13. A processor of a user equipment (UE) configured to perform operations comprising:
receiving a PxSCH configuration, wherein PxSCH represents a physical downlink shared channel (PDSCH) or a physical uplink shared channel (PUSCH), the PxSCH configuration including a time domain resource allocation (TDRA) table comprising one or more rows with at least one row containing multiple starting length and indicator values (SLIVs) and at least one repetition parameter;
receiving a scheduling downlink control information (DCI) indicating one or more rows of the TDRA table; and
determining a number of repetitions to apply to PxSCH transmissions based on the at least one repetition parameter.

14. The processor of claim 13, wherein the at least one repetition parameter includes an R parameter that is applied to the SLIVs in an indicated row of the TDRA table when a number of SLIVs K in the row is less than or equal to a value of N.

15. (canceled)

16. The processor of claim 13, wherein the at least one repetition parameter includes a respective R parameter for each SLIV in a row of the TDRA table.

17. The processor of claim 13, wherein the at least one repetition parameter includes a list of AggregationFactor (AF) parameters, wherein a given AF parameter is commonly applied for SLIVs having a same SLIV index number across rows of the TDRA table.

18. The processor of claim 13, wherein the at least one repetition parameter is provided in a new information field in the scheduling DCI.

19. (canceled)

20. The processor of claim 13, wherein at least two predefined repetition numbers are configured in the PxSCH configuration by RRC signaling, wherein a value for one of the predefined repetition numbers is indicated based on a scrambling sequence selected from a set of predefined sequences and used for scrambling the cyclic redundancy check (CRC) bits of the scheduling DCI.

21. (canceled)

22. The processor of claim 13, wherein a starting slot Kᵢ for a given SLIV i in the indicated row is determined by Kᵢ=n+K+i*R, where n is a slot of the scheduling DCI, K is K₀ for multi-PDSCH and K₂ for multi-PUSCH.

23. The processor of claim 13, wherein the UE does not expect to simultaneously receive, in the PxSCH configuration, both the TDRA table comprising one or more rows with at least one row containing multiple SLIVs and the at least one repetition parameter.

24. The processor of claim 13, wherein the operations further comprise:
receiving, in the PxSCH configuration, a parameter indicating a second transport block for the PxSCH transmissions or receptions is disabled.

25-28. (canceled)
